(19) United States
(12) Patent Application Publication
(10) Pub. No.: US 2007/0153870 A1
(43) Pub. Date: Jul. 5, 2007

(54) Assembly system of a thermocouple for gas turbine

(75) Inventors: Alessio Miliani, Impruneta (IT); Stefano Cocchi, Pisa (IT)

Correspondence Address: GENERAL ELECTRIC CO.;GLOBAL PATENT OPERATION, 187 Danbury Road, Suite 204, Wilton, CT, 06897-4122, US

(73) Assignee: NUOVO PIGNONE HOLDING S.P.A., Florence (IT)

(21) Appl. No.: 10/596,739

(22) PCT Filed: Dec. 16, 2004
(86) PCT No.: PCT/EP04/14467

§ 371 Date: Jun. 22, 2006

(30) Foreign Application Priority Data
Dec. 23, 2003 (IT) MI2003A 002586

(51) Int. Cl. G01K 3/00; G01K 7/00; G01K 1/00

(52) U.S. Cl. 374/116; 374/179; 374/208

(57) ABSTRACT

Assembly system (10) for a thermocouple (16) for a gas turbine equipped with a supporting element (12) in which the thermocouple (16) is housed, the supporting element (12) has a series of holes (45) for the inlet of the discharge gases of the gas turbine and a cavity (50) in which they are mixed before flowing through an opening (14) of the supporting element (12).

The present invention relates to an assembly system of a thermocouple for a gas turbine, in particular a gas turbine of the “heavy duty” type.

The technical sector relates to so-called “heavy duty” gas turbines, which are almost always controlled on the basis of the temperature of the discharge gases down-stream of the expander present therein.

A series of temperature sensors is normally housed downstream of the expander, which allows a series of signals to be obtained, that are proportional to the temperature which each of the temperature sensors detects in the surrounding area.

From the various temperature values, it is possible, by means of appropriate processing, to obtain an average temperature whose value, when further processed, provides the so-called “ignition” temperature of the gas turbine.

From an operative and functional point of view, it is therefore extremely important to have a temperature detection system in heavy duty turbines, which provides a reliable and repeatable measurement of the average temperature at the expander of the turbine itself as this greatly influences the performances and useful life of the machine.

As mentioned above, the average temperature is currently obtained by means of a series of temperature sensors, whose number varies according to the type of machine.

Furthermore, the series of temperature sensors is uniformly distributed on the expander along a circumference of a section of the expander itself.

One of the disadvantages which arise in the case of transients is that this type of solution is not capable of guaranteeing a reliable measurement of the average temperature of the discharge gases of the turbine.

This occurs when the temperature profile is not very uniform inside the section of the expander and also when it varies with time, as the average temperature value obtained from the series of temperature sensors may not be representative of the real average temperature of the turbine with a consequent risk for the efficient functioning of the turbine itself.

An objective of the present invention is to provide an assembly system of a thermocouple for a gas turbine which is simple and provides a reliable and repeatable measurement of the temperature of the discharge gases of the turbine itself.

A further objective is to provide an assembly system of a thermocouple for a gas turbine which allows a reliable measurement of the temperature of the discharge gases of the gas turbine, whatever the temperature profile may be in the discharge section.

Yet another objective is to provide an assembly system of a thermocouple for a gas turbine which also allows a reliable measurement of the temperature of the discharge gases of the gas turbine, even with variations in the temperature profile in the discharge section.

These objectives according to the present invention are achieved by providing an assembly system of a thermocouple for a gas turbine as specified in claim 1.

Further characteristics of the invention are indicated in the subsequent claims.

The characteristics and advantages of an assembly system of a thermocouple for a gas turbine according to the present invention will appear more evident from the following illustrative and non-limiting description, referring to the enclosed schematic drawings, in which:

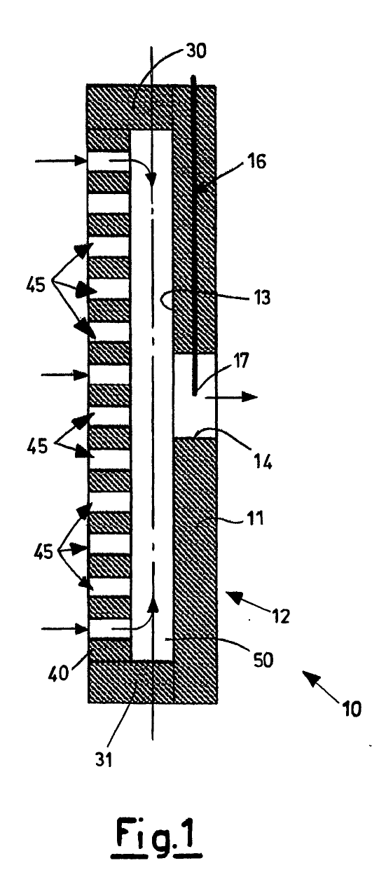

FIG. 1 is a raised side view of a preferred embodiment of an assembly system of a thermocouple for a gas turbine according to the present invention.

With reference to the figure, this illustrates an assembly system 10 of a thermocouple 16 for a gas turbine comprising a supporting element 12, which is substantially an internally hollow cylinder in which the thermocouple 16 is inserted.

The supporting element also has an opening 14 from which an end 17 of the thermocouple 16 protrudes.

A part of the discharge gases of the gas turbine flows through the opening 14.

Said opening 14 is positioned centrally on a surface 13 of a first portion 11 of the supporting element 12.

The supporting element 12 comprises a series of holes (45) and a cavity (50) for the mixing of these so as to make their temperature uniform in order to obtain more reliable temperature measurements.

The supporting element 12 also comprises a second portion 40 in which the series of pass-through holes 45 are situated, through which a part of the discharge gases whose temperature is to be measured, flows.

The first portion 11 and the second portion 40 substantially form the body, essentially a hollow cylinder, of the supporting element 12 of the assembly system for the thermocouple 16.

The first portion 11 and the second portion 40 are also both connected to a first base portion 30 and a second base portion 31.

The first base portion 30 and the second base portion 31 define a first end and a second end respectively of the supporting element 12.

The thermocouple is preferably inserted in the first base portion until it completely passes the first portion 11, and protrudes into the opening 14.

A series of pass-through holes 45 are situated on the second portion 40, for the mixing of the combusted gases, whose temperature is to be measured.

The series of holes 45 is preferably opposite the opening 14 with respect to the axis of the supporting element 12.

The first portion 11 and the second portion 40 also define a cavity 50 communicating with the series of holes 45 and with the opening 14 of the supporting element 12.

Said cavity 50 has the function of mixing the discharge gases which pass through the series of holes 45, subsequently sending them, mixed with each other, through the opening 14.

Mixing occurs as the passage through the cavity 50 causes a change in direction of the discharge gases with the formation of turbulences suitable for mixing them.

In this way, the discharge gases which pass through the opening 14 have a homogeneous and uniform temperature even with variations in the temperature profile of the discharge gases outside the assembly system 10.

This allows much more reliable temperature measurements to be effected, thus lengthening the useful life and reliability of the gas turbine in which said assembly system 10 is applied.

Furthermore, with the use of said assembly system 10, it is possible to obtain extremely satisfactory results, in the case of transients in the temperature profile of the discharge gases.

According to a preferred embodiment of the present invention, the first portion 11, the second portion 40 and the first and second base portion 30 and 31 can also be advantageously produced in different pieces.

It can thus be seen that an assembly system of a thermocouple for a gas turbine according to the present invention achieves the objectives specified above.

Numerous modifications and variants can be applied to the assembly system of a thermocouple for a gas turbine of the present invention, thus conceived, all included within the inventive concept.

Furthermore, in practice the materials used as also the dimensions and components can vary according to technical demands.

1. An assembly system (10) of a thermocouple (16) for a gas turbine comprising a supporting element (12) in which said thermocouple (16) is housed, characterized in that said supporting element (12) includes a series of holes (45) for the inlet of the discharge gases of the gas turbine and a cavity (50) in which they are mixed before flowing through an opening (14) of the supporting element (12).

2. The assembly system (10) according to claim 1, characterized in that said opening (14) of the supporting element (12) is positioned centrally with respect to a base surface (13) of a first portion (11) of the supporting element (12) itself.

3. The assembly system (10) according to claim 1, characterized in that said series of holes (45) is situated in a second portion (40) of the supporting element (12), and is opposite the opening (14) with respect to the axis of the supporting element (12).

4. The assembly system (10) according to claim 1, characterized in that said series of pass-through holes (45), said cavity (50) and said opening (14) are intercommunicating.

5. The assembly system (10) according to claim 1, characterized in that the thermocouple (16) has an end (17) which protrudes from the opening (14) of the supporting element (12).

6. The assembly system (10) according to claim 1, characterized in that said supporting element (12) is substantially an internally hollow cylinder.

7. The assembly system (10) according to claim 1, characterized in that said supporting element (12) comprises a first base portion (30) and a second base portion (31) both connected to the first portion (11) and the second portion (40) of the supporting element (12).

8. The assembly system (10) according to claim 1, characterized in that the supporting element (12), the element (30) and the portion (40) of the assembly system (10) are produced in one piece.

9. (canceled)
